(19) United States
(12) Patent Application Publication
(10) Pub. No.: US 2023/0346033 A1
(43) Pub. Date: Nov. 2, 2023

(54) VAPOR GENERATION DEVICE

(71) Applicant: SHENZHEN FIRST UNION TECHNOLOGY CO., LTD., Shenzhen City, Guangdong Province (CN)

(72) Inventors: RUILONG HU, Shenzhen City, Guangdong Province (CN); ZHIMING LU, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/021,174

(22) PCT Filed: Aug. 13, 2021
(86) PCT No.: PCT/CN2021/112526

§ 371 Date: Feb. 13, 2023

(30) Foreign Application Priority Data
Aug. 13, 2020 (CN) 202021693770.6

(51) Int. Cl. A24F 40/465; A24F 40/51; A24F 40/53

(52) U.S. Cl. CPC A24F 40/465; A24F 40/51; A24F 40/53

(57) ABSTRACT

This application provides a vapor generation device, including: a cavity, configured to receive a vapor generation product; a heater, configured to heat the vapor generation product received in the cavity; a wall, defining or forming at least a part of an airflow path of an airflow that passes through the vapor generation device during an inhaling process; a temperature sensor, configured to sense a temperature of the wall; and a circuit, programmed to determine an inhaling action of a user when the temperature sensor detects a temperature drop of the wall. In the vapor generation device, the temperature sensor is used to sense the temperature drop of the wall at least partially defining the airflow, to determine the inhalation of the user.

### CROSS-REFERENCE TO RELATED APPLICATIONS

This application claims priority to Chinese Patent Application No. 202021693770.6, filed with the China National Intellectual Property Administration on Aug. 13, 2020 and entitled “VAPOR GENERATION DEVICE”, which is incorporated herein by reference in its entirety.

### TECHNICAL FIELD

Embodiments of this application relate to the field of heat-not-burn cigarette device technologies, and in particular, to a vapor generation device.

### BACKGROUND

Tobacco products (such as cigarettes, cigars, and the like) burn tobacco during use to produce tobacco smoke. Attempts are made to replace these tobacco-burning products with products that release compounds without burning.

An example of such products is a heating device that releases compounds by heating rather than burning materials. For example, the materials may be tobacco or other non-tobacco products. These non-tobacco products may or may not contain nicotine. As a known heating device, a patent No. 201280060087.0 provides a method of monitoring an airflow change during an inhaling process of a user by detecting a power change, and then determining an inhaling action of the user according to the airflow change.

### SUMMARY

Embodiments of this application provide a vapor generation device, configured to heat a vapor generation product to generate an aerosol for inhalation, including: a cavity, configured to receive the vapor generation product; a heater, configured to heat the vapor generation product received in the cavity; a wall, defining or forming at least a part of an airflow path of an airflow that passes through the vapor generation device during an inhaling process; a temperature sensor, configured to sense a temperature of the wall; and a circuit, programmed to determine an inhaling action of a user in a case that the temperature sensor detects a temperature drop of the wall.

In the vapor generation device, the temperature sensor is used to sense the temperature drop of the wall at least partially defining the airflow, to determine inhalation of the user.

In a preferred implementation, the circuit is programmed to determine the inhaling action of the user upon detection that the temperature drop of the wall is in a range of 7° C. to 100° C.

In a preferred implementation, the wall is formed by at least a part of the heater.

In a preferred implementation, the vapor generation device further includes: a thermal conductive element, thermally conductive with the heater, where the wall is formed by at least a part of the thermal conductive element.

In a preferred implementation, the thermal conductive element is in contact with the heater.

In a preferred implementation, the heater is configured to extend along an axial direction of the cavity and surround at least a part of the cavity; the thermal conductive element is located upstream of the heater; the heater has an air inlet end portion close to the thermal conductive element in an axial direction; and the thermal conductive element is configured to provide an airflow path for external air to enter the air inlet end portion.

In a preferred implementation, the thermal conductive element is constructed in an annular shape arranged coaxially with the heater.

In a preferred implementation, the vapor generation device further includes: a support, located upstream of the heater, and configured to support the heater at the air inlet end portion, where the support is constructed in an annular shape and arranged coaxially with the heater; and the thermal conductive element is at least partially located in an annular hollow of the support.

In a preferred implementation, the temperature sensor is located and retained between an outer side wall of the thermal conductive element and an inner side wall of the support.

In a preferred implementation, the thermal conductive element is provided with a notch through which the air enters the air inlet end portion during use.

In a preferred implementation, the thermal conductive element is constructed to support the heater at the air inlet end portion.

In a preferred implementation, the heater is an infrared emitter that heats the vapor generation product by radiating an infrared ray to the vapor generation product received in the cavity, or the heater is an induction heater that heats the vapor generation product after being penetrated by a changing magnetic field, or the heater is a resistive heater.

### BRIEF DESCRIPTION OF THE DRAWINGS

One or more embodiments are exemplarily described with reference to the corresponding figures in the accompanying drawings, and the descriptions do not constitute a limitation to the embodiments. Components in the accompanying drawings that have same reference numerals are represented as similar components, and unless otherwise particularly stated, the figures in the accompanying drawings are not drawn to scale.

FIG. 1 shows a vapor generation device according to an embodiment of this application;

FIG. 2 is a schematic structural diagram of a heater and a thermal conductive element in FIG. 1;

FIG. 3 is a schematic diagram of the thermal conductive element in FIG. 2 on which a temperature sensor is arranged; and

FIG. 4 is a schematic structural diagram of a vapor generation device according to another embodiment.

### DETAILED DESCRIPTION

For ease of understanding of this application, this application is described below in more detail with reference to the accompanying drawings and specific implementations.

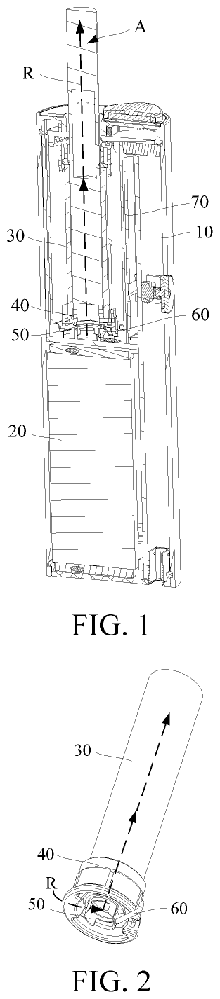

An embodiment of this application provides a vapor generation device of which the structure is shown in FIG. 1. The vapor generation device is configured to receive and heat a vapor generation product A, to produce at least one volatile component that volatilizes to form an aerosol for inhalation, where the vapor generation product A includes, but is not limited to, a cigarette. Base on functional requirements, the vapor generation device includes the following structural and functional components: a casing 10, a core 20, a heater 30, and a support 40.

The casing 10 is roughly square-shaped as a whole, that is, a dimension in a length direction is greater than a dimension in a width direction, and the dimension in the width direction is greater than a dimension in a thickness direction. Further, a cavity configured to receive the vapor generation product A is formed in the casing 10, and the cavity is configured to receive the vapor generation product A;

The core 20 is configured to supply power.

The heater 30 is constructed in a tubular shape that extends along an axial direction of the cavity and surrounds at least a part of the cavity. The heater 30 heats the vapor generation product by emitting an infrared ray to the surrounding vapor generation product A. In some embodiments, the heater 30 is an infrared emitter, which can be constructed by depositing an infrared emitting coating on a tubular infrared transparent substrate such as a quartz tube, or by wrapping an infrared emitting film. The infrared emitter can heat the vapor generation product A accommodated therein by radiating the infrared ray. In some embodiments, the heater 30 is an infrared emitter.

The support 40 is configured to support the heater 30 in the casing 10, to keep the heater 30 stable in the casing 10. Specifically, as shown in FIG. 1, the support 40 is arranged below the heater 30 and supports the heater 30 at a lower end portion of the heater 30. In some embodiments, the support 40 is constructed in an annular shape and arranged coaxially with the heater 30.

Further, in the preferred implementations shown in FIG. 1 and FIG. 2, the following components are further disposed in the casing 10:
a thermal conductive element 50, and a temperature sensor 60 sensing a temperature of the thermal conductive element 50.

In the preferred implementation shown in FIG. 2, the support 40 is constructed in the annular shape, and the lower end portion of the heater 30 abuts against a correspondingly arranged structure on the support 40 for abutment and fastening, such as a step, so as to be fastened.

The thermal conductive element 50 is located in an annular hollow of the support 40 and is thermally conductive with the heater 30. The thermal conductive element 50 can be heated by receiving heat of the heater 30.

As shown in FIG. 1 and FIG. 2, a path of an airflow during an inhaling process is shown by an arrow R, where the air passes through the hollow of the support 40 from a lower end and then enters the vapor generation product A in the heater 30. An inner wall of the thermal conductive element 50 is at least partially exposed to the airflow, thereby forming or defining the airflow path along which the external air enters the vapor generation product A in the heater 30 through the thermal conductive element 50 during the inhaling process.

It should be noted that the airflow formed during the inhaling process indicates that the support 40 and the thermal conductive element 50 are arranged upstream of the heater 30, not downstream. As used herein, terms “upstream” and “downstream” are used to denote an inhaling flow direction of the airflow passing through the vapor generation device during the inhaling process of a user, where the airflow direction is from “upstream” to “downstream”, thereby describing relative positions of elements, or parts of the elements, of the vapor generation device arranged along the airflow direction.

The temperature sensor 60 is closely attached to an outer wall of the thermal conductive element 50 by abutment or attachment. The temperature sensor 60 is configured to sense a temperature of the outer wall of the thermal conductive element 50, and the temperature sensor 60 is located between an outer side wall of the thermal conductive element 50 and an inner side wall of the support 40. The temperature sensor 60 senses a temperature change of an inner wall of the thermal conductive element 50. When passing through the inner wall of the thermal conductive element 50 during the inhaling process, cold air takes away heat of the inner wall of the thermal conductive element 50, thereby cooling the inner wall of the thermal conductive element 50.

It can be understood that to sense the temperature of the inner wall of the thermal conductive element 50, the temperature sensor 60 is not limited to be arranged on the outer wall of the thermal conductive element 50, and may be arranged at another position. For example: the temperature sensor 60 is arranged in a hollow cavity of the support 40, and the temperature sensor 60 is connected to the inner wall of the thermal conductive element 50 by using a thermal conductive connector, thereby sensing the temperature of the inner wall of the thermal conductive element 50.

A circuit board 70 integrated with a circuit can determine an inhaling action of the user by monitoring, by using the temperature sensor 60, a temperature drop of the inner wall of the thermal conductive element 50 during the inhaling process.

Further, according to the determined inhaling action of the user, the vapor generation device may record a count of inhalations of the user, and may also calculate consumption of the vapor generation product A cumulatively according to the count and duration of inhalations, and prevent the core 20 from outputting power when the calculated consumption is greater than a preset value, the core 20. The consumption of the vapor generation product A may be determined by determining the inhaling action through calculation, to monitor whether an inhaling amount of the user is excessive or the vapor generation product A is used up, thereby stopping heating when the inhaling amount is excessive or the vapor generation product A is used up.

Alternatively, in other implementations, the user may be informed, in real time, of the recorded or calculated count of inhalations and consumption through a UI interface of a display screen arranged on the vapor generation device or a component with a reminder function.

In a preferred embodiment, the thermal conductive element 50 uses materials that conduct heat fast, such as copper, silver, aluminum, gold or and alloy thereof.

In an optional implementation, the temperature sensor 60, for example, is a thermocouple, or a PTC/NTC temperature sensor, or a conductive pattern/track with a positive or negative resistive temperature coefficient formed on the thermal conductive element 50.

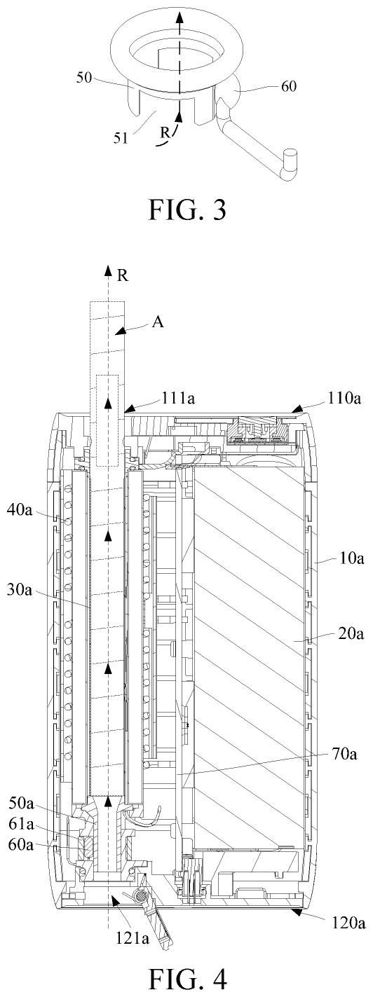

Further referring to the preferred implementation in FIG. 3, the thermal conductive element 50 is also roughly in an annular shape, and an internal space of the thermal conductive element 50 provides a part of a path of an airflow R.

To improve a contact area with the airflow and facilitate air inflow, the thermal conductive element 50 is provided with a notch 51 for the air to enter the interior. During use, the external air enters the thermal conductive element 50 through the notch 51 and flows to the heater 30, as shown by the arrow R in FIG. 3.

In the preferred implementation shown in FIG. 3, the temperature sensor 60 is fastened to the outer wall of the thermal conductive element 50 in a manner of gluing or the like. In this case, the temperature sensor 60 abuts against the inner wall of the support 40 and is stably maintained between the thermal conductive element 50 and the support 40.

In an optional implementation, the thermal conductive element 50 receives heat from the heater 30 through direct contact with the heater 30 after assembly.

FIG. 4 is a schematic structural diagram of a vapor generation device according to another embodiment. The vapor generation device includes:
a casing 10a, which is roughly square-shaped as a whole, that is, a dimension in a length direction is greater than a dimension in a width direction, and the dimension in the width direction is greater than a dimension in a thickness direction. The casing 10a includes a near end 110a and a far end 120a opposite to each other in the length direction, and during use, the near end 110a is used as an end portion close to a user for the user to inhale and operate a vapor generation product A.

Further, the near end 110a is provided with a first opening 111a, and during use, the vapor generation product A may be received in the casing 10a for heating or removed from the casing through the first opening 111a.

The far end 120a is provided with a second opening 121a opposite to the first opening 111a. On the one hand, the second opening 121a is used as an air inlet for external air to enter during an inhaling process, and may further be used as a cleaning port to allow a cleaning tool, such as a thin stick and an iron wire, to enter the casing 10a to clean an interior of the casing 10a.

Further, a cavity configured to receive the vapor generation product A is formed between the first opening 111a and the second opening 121a in the casing 10a. A core 20a, an induction heater 30a, an induction coil 40a, a second thermal conductive element 50a, and a temperature sensor 60a are further disposed in the casing 10a.

The core 20a is configured to supply power.

The induction heater 30a is constructed in a tubular shape surrounding at least a part of the cavity. In the preferred embodiment shown in FIG. 1, the induction heater 30a generates heat after being penetrated by a changing magnetic field and then heats the vapor generation product A;

The induction coil 40a extends along a length of the induction heater 30a and surrounds the induction heater 30a, so that during use, the induction heater 30a may be induced to generate heat through the changing magnetic field;

The second thermal conductive element 50a is located between the induction heater 30a and the second opening 121a, and supports a lower end of the induction heater 30a.

The second thermal conductive element 50a is constructed to be hollow and tubular, and a hollow inside the second thermal conductive element 50a is used to provide an airflow path for the external air to enter the cavity via the second opening 121a during inhalation. During the inhaling process, as shown by the arrow R in FIG. 4, after entering via the second opening 121a, the external air enters the vapor generation product A of the induction heater 30a through the second thermal conductive element 50a to be inhaled. The second thermal conductive element 50a is located upstream of the induction heater 30a.

The temperature sensor 60a is closely attached to an outer wall of the second thermal conductive element 50a, and is configured to sense a temperature of the second thermal conductive element 50a, so that a circuit board 70a determines an inhaling action of a user through a temperature drop of the second thermal conductive element 50a when an airflow passes through the second thermal conductive element 50a.

In still another preferred implementation, a heating temperature of the induction heater 30a is generally maintained in a range from 280° C. to 320° C. in the implementation, and the temperature of the second thermal conductive element 50a is lower than that of the induction heater 30a, and is about 50° C. to 180° C. It is appropriate that the circuit board 70 is specifically programmed to determine the inhalation of the user when it is detected that the temperature drop of the thermal conductive element 50 is in a range of 7° C. to 100° C. In a more preferred implementation, it may be more accurate to determine the inhalation of the user when it is detected that the temperature drop of the thermal conductive element 50 is in a range of 20° C. to 70° C.

In the preferred implementation shown in FIG. 4, the vapor generation device further includes an annular holding element 61a sleeved outside the second thermal conductive element 50a. The holding element 61a and the second thermal conductive element 50a jointly clamp the temperature sensor 60a, so as to fix and hold the temperature sensor 60a closely attached to the outer wall of the second thermal conductive element 50a.

Alternatively, in other optional implementations, the vapor generation device may heat the vapor generation product A through resistive heating. Specifically, for example, the vapor generation product A is heated by a resistive heater after a resistive heating track is formed on a tubular electrically insulating substrate such as a ceramic tube, a PI (polyimide) film, or the like.

Alternatively, in other optional implementations, the inhaling action of the user is determined by detecting a temperature drop of an extended part of the heater, thereby determining the inhalation of the user by monitoring the temperature drop of the extended part of the heater during inhalation. Certainly, it should be noted that a tubular part extending from the heater does not accommodate or receive the vapor generation product A. Alternatively, for example, in other optional implementations, the heater 30 includes a quartz tube substrate and an infrared emitting coating formed on the quartz tube substrate. The infrared emitting coating does not completely cover a surface of the quartz tube substrate, so that a part of a wall of the quartz tube substrate extending downward is exposed, and then the exposed part forms a wall whose temperature is sensed by the temperature sensor, thereby sensing the inhaling action of the user.

It should be noted that the specification of this application and the accompanying drawings thereof illustrate preferred embodiments of this application, but are not limited to the embodiments described in this specification. Further a person of ordinary skill in the art may make improvements or modifications according to the foregoing description, and all the improvements and modifications shall fall within the protection scope of the attached claims of this application.

1. A vapor generation device, configured to heat a vapor generation product to generate an aerosol for inhalation, comprising:
a cavity, configured to receive the vapor generation product;
a heater, configured to heat the vapor generation product received in the cavity;
a wall, defining or forming at least a part of an airflow path of an airflow that passes through the vapor generation device during an inhaling process;
a temperature sensor, configured to sense a temperature of the wall; and
a circuit, programmed to determine an inhaling action of a user in a case that the temperature sensor detects a temperature drop of the wall.

2. The vapor generation device according to claim 1, wherein the circuit is programmed to determine the inhaling action of the user upon detection that the temperature drop of the wall is in a range of 7° C. to 100° C.

3. The vapor generation device according to claim 1, wherein the wall is formed by at least a part of the heater.

4. The vapor generation device according to claim 1, further comprising:
a thermal conductive element, thermally conductive with the heater, wherein the wall is formed by at least a part of the thermal conductive element.

5. The vapor generation device according to claim 4, wherein the thermal conductive element is in contact with the heater.

6. The vapor generation device according to claim 4, wherein the heater is constructed to extend along an axial direction of the cavity and surround at least a part of the cavity; the thermal conductive element is located upstream of the heater;
the heater has an air inlet end portion close to the thermal conductive element in an axial direction; and
the thermal conductive element is configured to provide an airflow path for external air to enter the air inlet end portion.

7. The vapor generation device according to claim 6, wherein the thermal conductive element is constructed in an annular shape arranged coaxially with the heater.

8. The vapor generation device according to claim 7, further comprising:
a support, located upstream of the heater, and configured to support the heater at the air inlet end portion, wherein the support is constructed in an annular shape and arranged coaxially with the heater; and
the thermal conductive element is at least partially located in an annular hollow of the support.

9. The vapor generation device according to claim 8, wherein the temperature sensor is located and retained between an outer side wall of the thermal conductive element and an inner side wall of the support.

10. The vapor generation device according to claim 7, wherein the thermal conductive element is provided with a notch through which the air enters the air inlet end portion during use.

11. The vapor generation device according to claim 6, wherein the thermal conductive element is constructed to support the heater at the air inlet end portion.

12. The vapor generation device according to claim 1, wherein the heater is an infrared emitter that heats the vapor generation product by radiating an infrared ray to the vapor generation product received in the cavity, or the heater is an induction heater that heats the vapor generation product after being penetrated by a changing magnetic field, or the heater is a resistive heater.

13. The vapor generation device according to claim 2, wherein the wall is formed by at least a part of the heater.

14. The vapor generation device according to claim 2, further comprising:
a thermal conductive element, thermally conductive with the heater, wherein the wall is formed by at least a part of the thermal conductive element.

15. The vapor generation device according to claim 14, wherein the thermal conductive element is in contact with the heater.

16. The vapor generation device according to claim 14, wherein the heater is constructed to extend along an axial direction of the cavity and surround at least a part of the cavity; the thermal conductive element is located upstream of the heater;
the heater has an air inlet end portion close to the thermal conductive element in an axial direction; and
the thermal conductive element is configured to provide an airflow path for external air to enter the air inlet end portion.

17. The vapor generation device according to claim 16, wherein the thermal conductive element is constructed in an annular shape arranged coaxially with the heater.

18. The vapor generation device according to claim 16, wherein the thermal conductive element is constructed to support the heater at the air inlet end portion.

19. The vapor generation device according to claim 2, wherein the heater is an infrared emitter that heats the vapor generation product by radiating an infrared ray to the vapor generation product received in the cavity, or the heater is an induction heater that heats the vapor generation product after being penetrated by a changing magnetic field, or the heater is a resistive heater.
